(19) United States
(12) Patent Application Publication
(10) Pub. No.: US 2018/0264565 A1
(43) Pub. Date: Sep. 20, 2018

(54) Circular Saw with a Double-Belt Gear Reduction Mechanism

(71) Applicant: P&F Brother Industrial Corporation, Taichung (TW)

(72) Inventors: Chih-Yung Huang, Taichung (TW); Ta-Chang Liu, Taichung (TW); Yu-Tien Chen, Taichung (TW); Tien-Yun Chang, Taichung (TW)

(21) Appl. No.: 15/458,073

(22) Filed: Mar. 14, 2017

(51) Int. Cl. B23D 47/12; B23D 45/02

(52) U.S. Cl. CPC B23D 47/12; B23D 45/021

(57) ABSTRACT

A circular saw includes a machine housing disposed on a base to cooperatively define a working space therebetween, and a saw blade driven by a driving motor so as to rotate through a drive transmitting device accommodated in the machine housing. The device includes a first input shaft driven by the motor and having a first leading wheel mounted thereon, a middle shaft having a first trailing wheel and a second leading wheel mounted thereon to be rotated with the first input shaft through a first transmitting belt, a second input shaft having a second trailing wheel mounted thereon to be rotated with the middle shaft through a second transmitting belt, and a gear reduction device disposed to couple the second input shaft to the saw blade.

### FIELD

The disclosure relates to a gear reduction mechanism for a circular saw, and more particularly to a circular saw with a double-belt gear reduction mechanism.

### BACKGROUND

Referring to FIG. 1, a conventional circular saw includes a machine housing 1, a driving motor 2 disposed in the machine housing 1, a driving shaft 3 driven by the driving motor 2 to rotate a driving wheel 4, an output shaft 5 pivotably mounted in the machine housing 1, a driven wheel 6 disposed on and rotated with the output shaft 5, and a transmitting belt 7 trained on the driving and driven wheels 4, 6 such that a rotational drive is transmitted from the driving motor 2 to rotate the output shaft 5. The output shaft 5 is coupled to a saw blade 8 through a gear reduction mechanism (not shown) for rotating the saw blade 8.

Due to such arrangement of the driven wheel 6 and the transmitting belt 7 which limits the contour of the machine housing 1, the conventional circular saw is not suitable for cutting a workpiece with a larger thickness because of the presence of the machine housing 1.

### SUMMARY

Therefore, an object of the disclosure is to provide a circular saw that can alleviate at least one of the drawbacks of the prior art.

According to the disclosure, the circular saw includes a base, a machine housing, a driving motor, a saw blade and a drive transmitting device. The machine housing is disposed on the base and cooperates with the base to define a working space therebetween. The machine housing has a housing wall which extends in an axial direction to terminate at inner and outer sides and which defines an accommodation space therein. The driving motor is disposed on and extends from the inner side of the housing wall in the axial direction, and has a rotor which is rotatable about a rotor axis that extends in the axial direction. The saw blade is disposed in the working space and near the base, and is rotatable about a rotating axis parallel to the rotor axis. The drive transmitting device is disposed in the accommodation space, and includes a first input shaft coaxially rotatable with the rotor about the rotor axis, a second input shaft disposed near the saw blade and rotatable relative to the housing about an input axis that is parallel to the rotor axis and that is distant from the rotor axis by a first distance, a middle shaft interposed between the first and second input shafts and rotatable about a middle axis that is parallel to the rotor axis and that is distant from the rotor axis and the input axis by second and third distances, respectively, a first leading wheel disposed on and rotated with the first input shaft, a first trailing wheel disposed on the middle shaft, a first transmitting belt trained on the first leading and trailing wheels such that a first rotating drive is transmitted from the motor to rotate the first trailing wheel and the middle shaft about the middle axis, a second leading wheel disposed on and rotated with the middle shaft, a second trailing wheel disposed on the second input shaft, a second transmitting belt trained on the second leading and trailing wheels such that a second rotating drive is transmitted from the middle shaft to rotate the second trailing wheel and the second input shaft about the input axis, and a gear reduction unit disposed to couple the second input shaft to the saw blade so as to generate a speed-reduction drive transmitted from the second input shaft to rotate the saw blade about the rotating axis.

The first and second transmitting belts are disposed adjacent to the outer side of the housing wall. A sum of the second and third distances is larger than the first distance.

### BRIEF DESCRIPTION OF THE DRAWINGS

Other features and advantages of the disclosure will become apparent in the following detailed description of the embodiment with reference to the accompanying drawings, of which:

FIG. 1 is a schematic side view of a conventional circular saw;

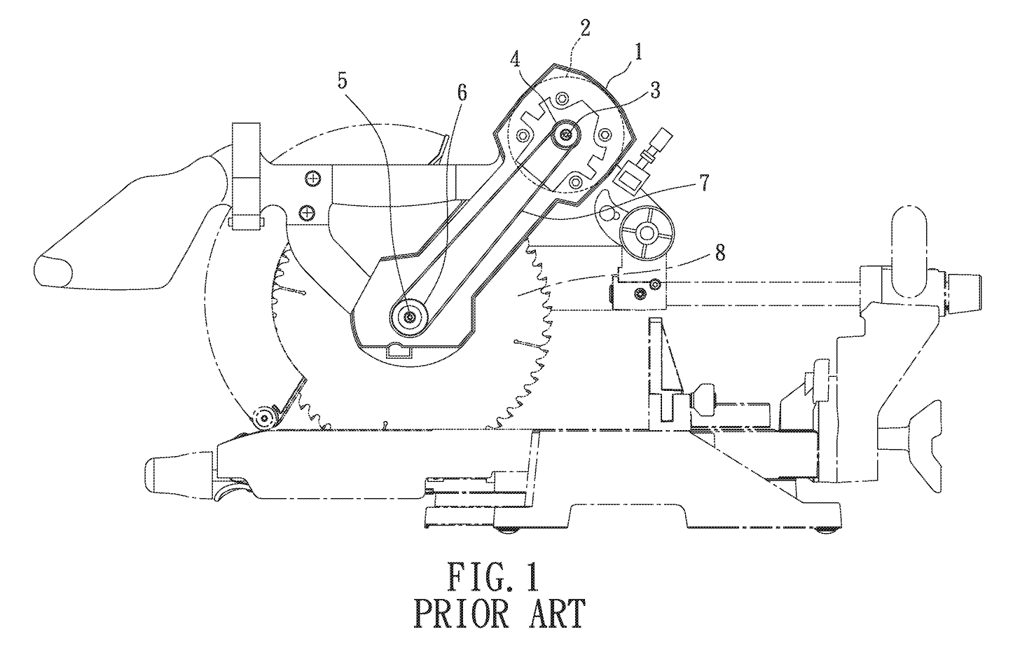

FIG. 2 is a schematic side view of an embodiment of a circular saw according to the disclosure;

FIG. 3 is a perspective view of a portion of the embodiment;

FIG. 4 is a schematic front view of the embodiment; and

FIG. 5 is a fragmentary perspective view of a drive transmitting device of the embodiment.

### DETAILED DESCRIPTION

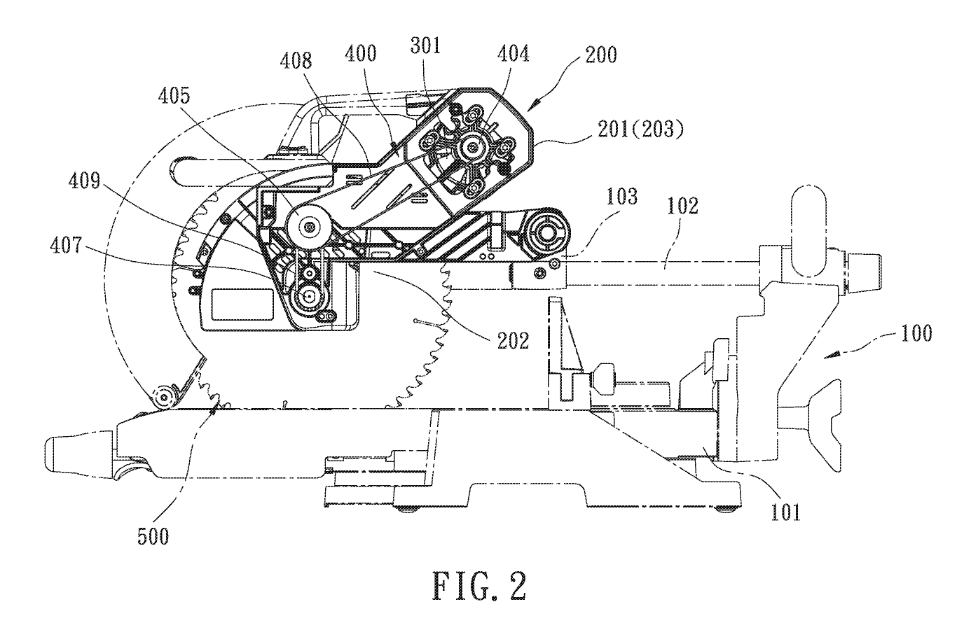

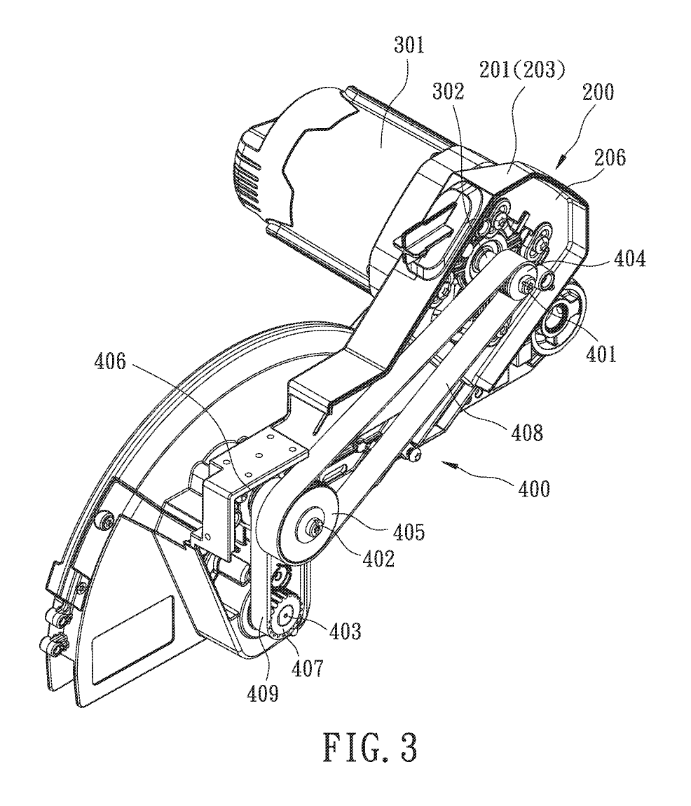

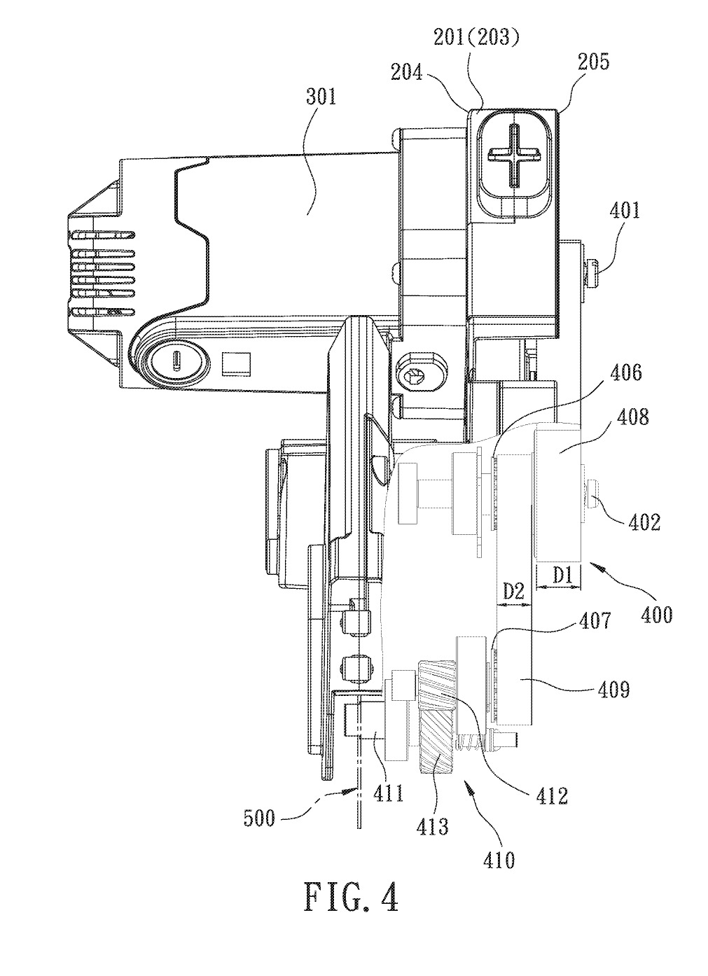

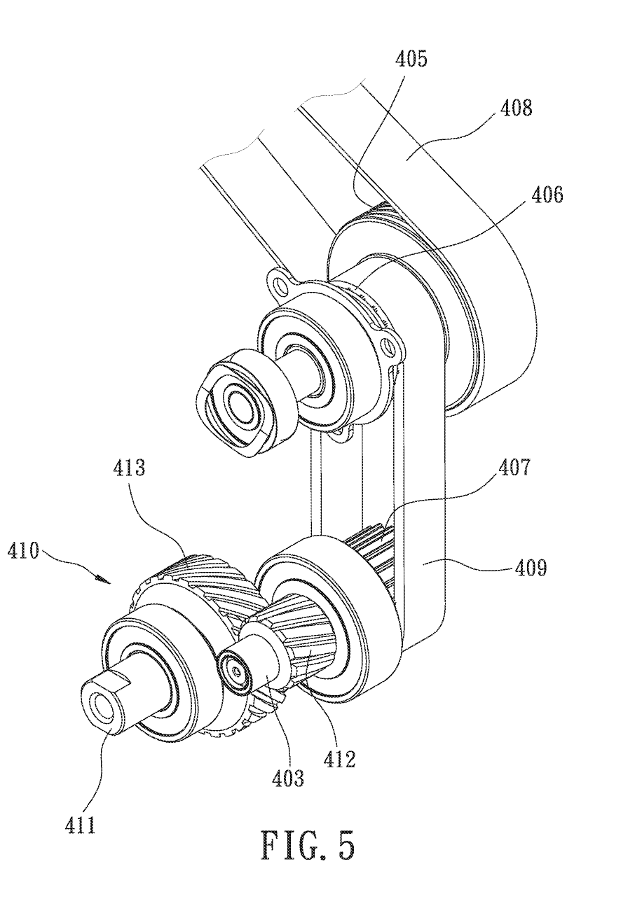

Referring to FIGS. 2 to 5, an embodiment of a circular saw according to this disclosure is shown to include a base 100, a machine frame 200, a driving motor 301, a drive transmitting device 400 and a saw blade 500.

The base 100 includes a base seat 101, a guiding rod 102 disposed on the base seat 101, and a sliding member 103 slidably connected to the guiding rod 102.

The machine frame 200 is pivotably mounted on the sliding member 103, and includes a machine housing 201 which cooperates with the base seat 101 to define a working space 202 therebetween. The machine housing 201 has a housing wall 203 which extends in an axial direction to terminate at inner and outer sides 204, 205 and which defines an accommodation space 206 therein. The driving motor 301 is disposed on and extends from the inner side 204 of the housing wall 203 in the axial direction. The driving motor 301 has a rotor 302 which is rotatable about a rotor axis that is normal to the housing wall 203. The saw blade 500 is disposed in the working space 202 and near the base seat 101, and is rotatable about a rotating axis parallel to the rotor axis of the rotor 302.

The drive transmitting device 400 is disposed in the accommodation space 206 of the machine housing 201, and includes a first input shaft 401 coaxially rotatable with the rotor 302 about the rotor axis, a second input shaft 403 disposed near the saw blade 500 and rotatable relative to the housing 201 about an input axis that is parallel to the rotor axis and that is distant from the rotor axis by a first distance, a middle shaft 402 interposed between the first and second input shafts 401, 403 and rotatable about a middle axis that is parallel to the rotor axis and that is distant from the rotor axis and the input axis by second and third distances, respectively, a first leading wheel 404 disposed on and rotated with the first input shaft 401, a first trailing wheel 405 disposed on the middles haft 402, a first transmitting belt 408 trained on the first leading and trailing wheels 404, 405 such that a first rotating drive is transmitted from the motor 301 to rotate the first trailing wheel 405 and the middle shaft 402 about the middle axis, a second leading wheel 406 disposed on and rotated with the middle shaft 402, a second trailing wheel 407 disposed on the second input shaft 403, a second transmitting belt 409 trained on the second leading and trailing wheels 406, 407 such that a second rotating drive is transmitted from the middle shaft 402 to rotate the second trailing wheel 407 and the second input shaft 403 about the input axis, and a gear reduction unit 410 disposed to couple the second input shaft 403 to the saw blade 500 so as to generate a speed-reduction drive transmitted from the second input shaft 403 to rotate the saw blade 500 about the rotating axis. The first and second transmitting belts 408, 409 are disposed adjacent to the outer side 205 of the housing 201 so as to facilitate maintenance and replacement thereof, as well as heat dissipation of the drive transmitting device 400. A sum of the second and third distances is larger than the first distance.

In this embodiment, the gear reduction unit 410 includes an output shaft 411 extending along the rotating axis such that the saw blade 500 is disposed on and rotated with the output shaft 411, a first reduction gear 412 disposed on and rotated with the second input shaft 403, and a second reduction gear 413 disposed on the output shaft 411 and meshing with the first reduction gear 412 so as to generate the speed-reduction drive to rotate the output shaft 411 and the saw blade 500 about the rotating axis. Each of the first and second reduction gears 412, 413 is in a form of a helical gear to make the input axis and the rotating axis substantially parallel to each other. In this embodiment, the second leading and trailing wheels 406, 407 have a same diameter.

The second transmitting belt 409 has a width (D2) smaller than a width (D1) of the first transmitting belt 408.

For example, when the driving motor 301 is actuated to drive rotation of the first input shaft 401 and the first leading wheel 404 at a rotational speed of at least about 20000 rpm, through the first transmitting belt 408, the first trailing wheel 405 and the middle shaft 402, a rotation drive is transmitted to rotate the second leading wheel 406 at a reduced rotational speed of about 9000-11000 rpm, and through the second transmitting belt 409, the second trailing wheel 407, the second input shaft 403 and the gear reduction unit 410, a reduced rotational drive is transmitted to rotate the output shaft 411 at a further reduced rotational speed of about 3000-4000 rpm so as to rotate the saw blade 500 on the output shaft 411.

As taken from a side view of FIG. 2, the first leading wheel 404 is disposed at an upper-right end of the housing 201. The second trailing wheel 407 is disposed below the first trailing wheel 405. The first transmitting belt 408 is extended rightwardly and upwardly, and the second transmitting belt 409 is extended downwardly. With such arrangement of the first and second transmitting belts 408, 409, the contour of the housing wall 203 of the housing 201 renders the working space 202 sufficiently enlarged for accommodating a workpiece with a larger thickness.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

1. A circular saw comprising:
a base;
a machine housing disposed on said base and cooperating with said base to define a working space therebetween, said machine housing having a housing wall which extends in an axial direction to terminate at inner and outer sides and which defines an accommodation space therein and between said inner and outer sides;
a driving motor disposed on and extending outwardly from said inner side of said housing wall in the axial direction, and having a rotor which is rotatable about a rotor axis that extends in the axial direction;
a saw blade disposed in said working space and near said base, and rotatable about a rotating axis parallel to the rotor axis; and
a drive transmitting device disposed in said accommodation space, and including a first input shaft coaxially rotatable with said rotor about the rotor axis, a second input shaft disposed near said saw blade and rotatable relative to said housing about an input axis that is parallel to the rotor axis and that is distant from the rotor axis by a first distance, a middle shaft interposed between said first and second input shafts and rotatable about a middle axis that is parallel to the rotor axis and that is distant from the rotor axis and the input axis by second and third distances, respectively, a first leading wheel disposed on and rotated with said first input shaft, a first trailing wheel disposed on said middle shaft, a first transmitting belt trained on said first leading and trailing wheels such that a first rotating drive is transmitted from said motor to rotate said first trailing wheel and said middle shaft about the middle axis, a second leading wheel disposed on and rotated with said middle shaft, a second trailing wheel disposed on said second input shaft, a second transmitting belt trained on said second leading and trailing wheels such that a second rotating drive is transmitted from said middle shaft to rotate said second trailing wheel and said second input shaft about the input axis, and a gear reduction unit disposed to couple said second input shaft to said saw blade so as to generate a speed-reduction drive transmitted from said second input shaft to rotate said saw blade about the rotating axis, said first and second transmitting belts being disposed outwardly of said inner side and adjacent to said outer side of said housing wall, a sum of the second and third distances being larger than the first distance.

2. The circular saw as claimed in claim 1, wherein said gear reduction unit includes an output shaft extending along the rotating axis such that said saw blade is disposed on and rotated with said output shaft, a first reduction gear disposed on and rotated with said second input shaft, and a second reduction gear disposed on said output shaft and meshing with said first reduction gear so as to generate the speed-reduction drive to rotate said output shaft and said saw blade about the rotating axis.

3. The circular saw as claimed in claim 2, wherein each of said first and second reduction gears is a helical gear to make the input axis and the rotating axis substantially parallel to each other.

4. The circular saw as claimed in claim 1, wherein said second leading and trailing wheels have a same diameter.

5. The circular saw as claimed in claim 1, wherein said second transmitting belt has a width smaller than that of said first transmitting belt.
